(19) United States
(12) Patent Application Publication
(10) Pub. No.: US 2008/0078914 A1
(43) Pub. Date: Apr. 3, 2008

(54) TRIPOD STAND

(76) Inventor: Tsun-Wu LIAO, Taichung City (TW)

Correspondence Address: LEONG C LEI, PMB # 1008, 1867 YGNACIO VALLEY ROAD, WALNUT CREEK, CA, 94598, US

(21) Appl. No.: 11/532,540

(22) Filed: Sep. 18, 2006

(51) Int. Cl. F16M 11/38

(52) U.S. Cl. 248/435

(57) ABSTRACT

A tripod stand is provided herein which offers a more reliable extension of the supporting rod's inner tube. A first opening is provided in a middle section of the outer tube of the tripod stand's telescoping rod. Correspondingly, a second opening is provided on the center ring of the tripod. Then, a washer is positioned between the first and second openings. To use the tripod stand, the first and second openings are aligned and the inner tube of the telescoping rod is extended to a desired height, a bolt is then screwed through the aligned first and second openings to tightly press against the inner tube via the washer.

### TECHNICAL FIELD OF THE INVENTION

The present invention generally relates to tripod stands, and more particularly to a tripod stand having an additional fixation mechanism for the telescoping inner tube.

### DESCRIPTION OF THE PRIOR ART

A conventional tripod stand for supporting, say, a drum set, as shown in FIGS. 5 to 7, contains a telescoping rod vertically mounted on a tripod 21 through a center ring 22 of the tripod 21. The telescoping rod is composed of an outer tube 20 and an inner tube 23. To use the tripod stand, the inner tube 23 is extended for an appropriate distance and is then fixed by a fastening member installed at the top end around the outer tube 20. The fastening member contains a tubular body 24 having a side knob 26 and a tubular piece 25 sleeved inside. The top end of the outer tube 20 is squeezed by the fastening member through tightening the side knob 26 so as to fixedly hold the inner tube 23 at the specific extension distance. When the inner tube 23 is used to support a heavy drum set, the gravity together with the force of beating the drum set will push the inner tube 23 to retract into the outer tube 20. To prevent the inner tube 23 from retracting too far into the outer tube 20, a ring block 27 is provided at an appropriate location around the inner tube 23. As such, the sliding-down movement of the inner tube 23 will be limited when the ring block 27 is stopped by the fastening member. As described, this approach cannot resolve the inner tube 23's sliding problem but only limits the inner tube 23's sliding within a certain extent.

As shown in FIGS. 8 and 9, another conventional approach is to provide a number of pairs of axially opposing holes 28 along the length of the inner tube 23. Also, a pair of axially opposing holes (not numbered) is provided at an appropriate location on the outer tube 20. Then, by aligning a pair of holes of the inner tube 23 with the pair of holes of the outer tube 20 and by running a pin 29 axially though these aligned holes, the inner tube 23 is more steadily positioned. This approach has a number of disadvantages. First, the structural strength of the inner tube 23 is inevitably deteriorated by these holes. In addition, as the apertures of the holes are usually larger than the diameter of the pin 29, the inner tube 23 would shake, especially when beating the drum set. Furthermore, this design would limit the inner tube 23 to be extended at some fixed locations, reducing the application flexibility of the tripod stand.

### SUMMARY OF THE INVENTION

The primary purpose of the present invention is to provide a tripod stand which offers a more reliable extension of the supporting rod's inner tube.

According to the present invention, a first opening is provided in a middle section of the outer tube of the tripod stand's telescoping rod. Correspondingly, a second opening is provided on the center ring of the tripod. Then, a washer is positioned between the first and second openings.

To use the tripod stand, the first and second openings are aligned and the inner tube of the telescoping rod is extended to a desired height, a bolt is then screwed through the aligned first and second openings to tightly press against the inner tube via the washer. According to the present invention, the extension of the inner tube is secured by the foregoing additional fixation mechanism and, on the other hand, is not limited to fixed locations. Furthermore, the surface of the inner tube is protected by the washer from being scratched by the squeezing-in bolt.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective exploded view showing the various components of a tripod stand according to an embodiment of the present invention.

FIG. 2 is a perspective view showing the tripod stand of FIG. 1 after its assembly.

FIG. 3 is a schematic sectional view showing the fixation of the inner tube of FIG. 1.

FIG. 4 is a perspective and exposed view showing the details of the fixation of the inner tube of FIG. 1.

FIG. 5 is a perspective exploded view showing the various components of a conventional tripod stand.

FIG. 6 is a perspective view showing the convention tripod stand of FIG. 5 after its assembly.

FIG. 7 is a schematic sectional view showing the details of the fixation of the inner tube of FIG. 5.

FIG. 8 is a perspective view showing another conventional tripod stand.

FIG. 9 is a schematic sectional view showing the details of the fixation of the inner tube of FIG. 8.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

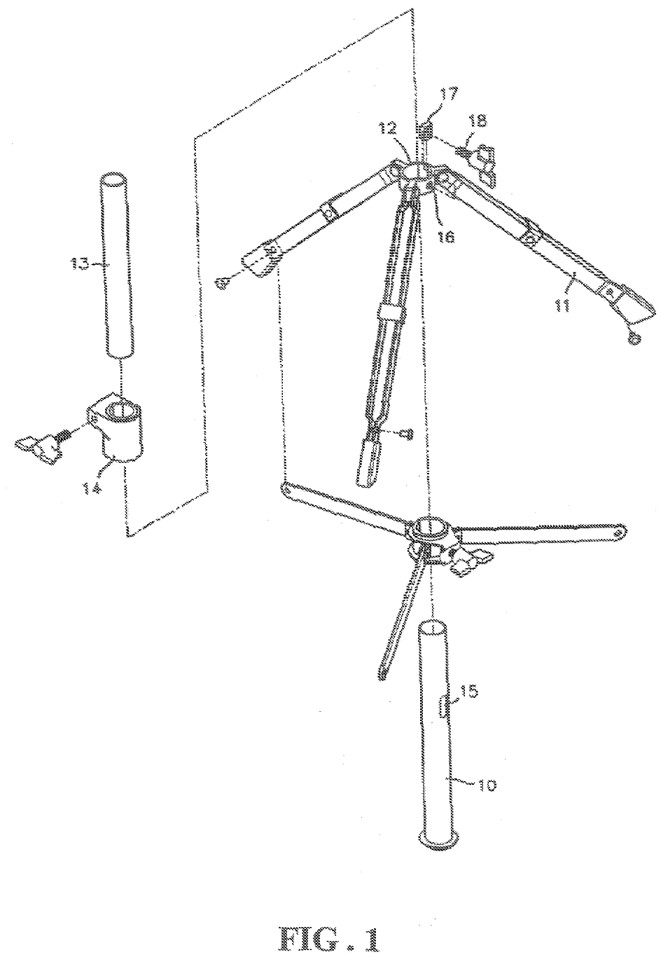

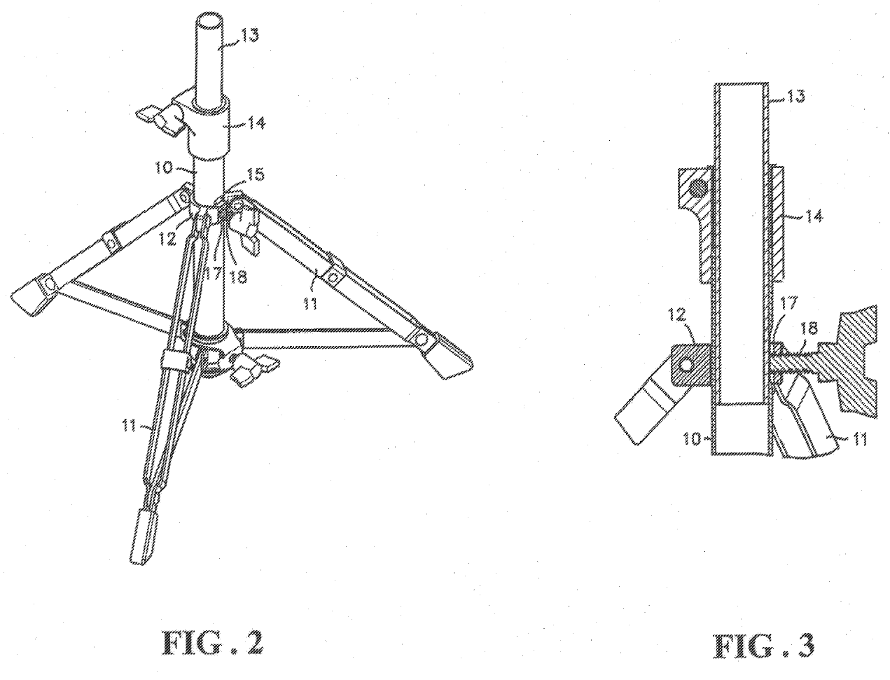

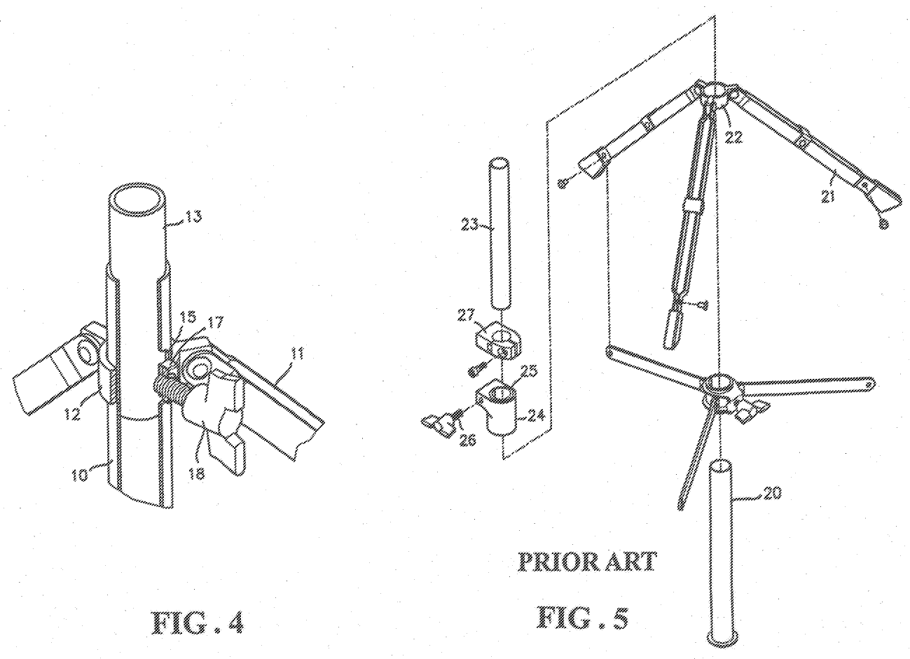

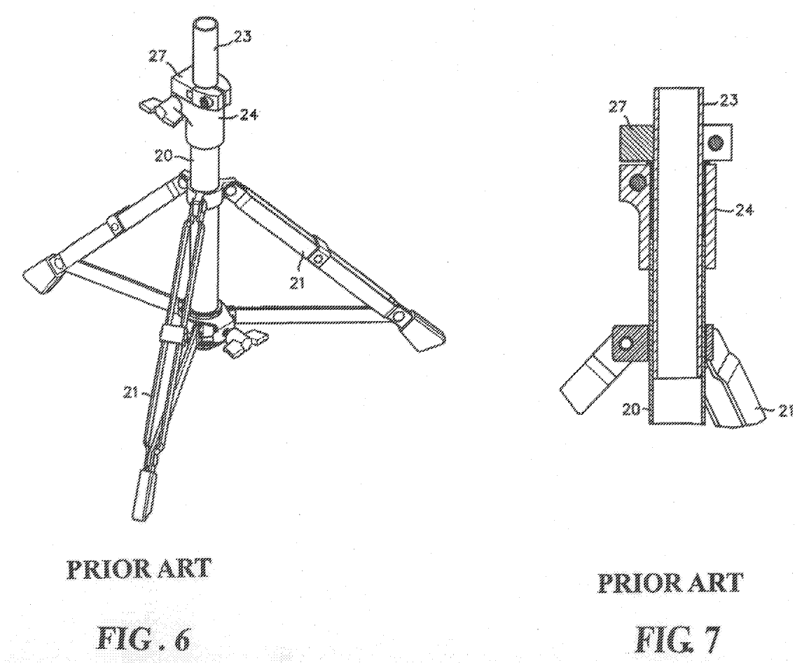

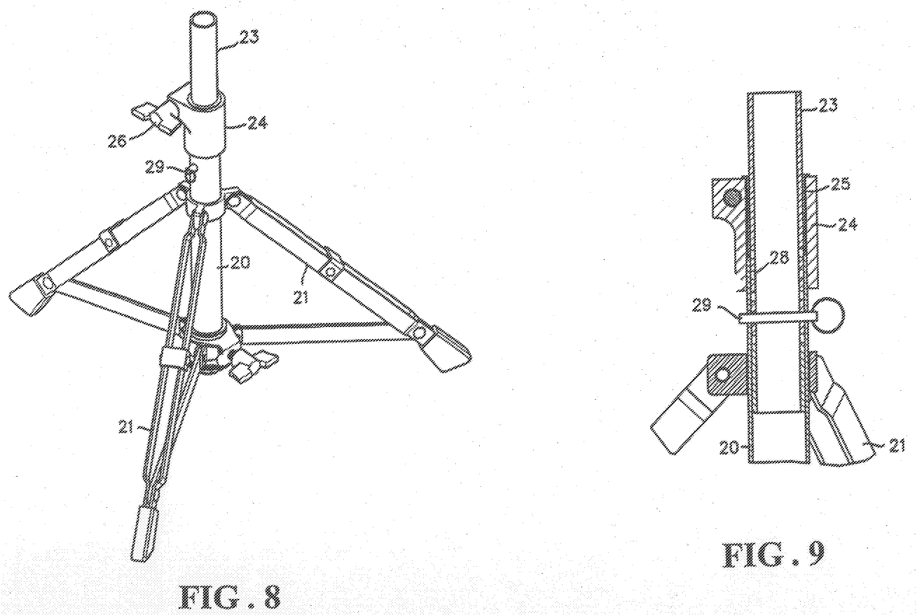

The present invention provides a tripod stand in supporting various types of objects. One typical application of the tripod stand is to support a drum set. As shown in FIGS. 1 to 4, the tripod stand contains a telescoping rod mounted on a tripod 11 for supporting the drum set or other object. The telescoping rod is threaded through a center ring 12 of the tripod 11 and contains an outer tube 10 and an inner tube 13 retractably sleeved inside the outer tube 10. A fastening member 14 is provided at the top end around the outer tube 10 and, by squeezing the top end of the outer tube 10 through the fastening member 14, the inner tube 13 is fixedly extended for a specific distance from the outer tube 10.

According to the present invention, a first opening 15 is provided on the circumference of the outer tube 10 in a middle section where the outer tube 10 and the center ring 12 of the tripod 11 interface with each other. Correspondingly, a second opening 16 is provided on the circumference of the center ring 12 and aligned with the first opening 15. On the other hand, an inversed-U-shaped or L-shaped washer 17 can be supported by the top rim of the center ring 12 and extended downward between the first and second openings 15 and 16. Please note that, when the washer 17 has the unversed-U shape, the outer leg of the washer 17 is a through hole aligned with and corresponding to the first and second openings 15 and 16.

When the tripod stand is put to use, the inner tube 13 is first raised to a desired height and fixed there by tightening the fastening member 14. Then a bolt 18 is screwed from outside, through the second opening 16 of the center ring 12, to squeeze on the inner tube 13 by pressing the washer 17 via the first opening 15. As such, the fixation of the inner tube 13 is more robust than the prior arts.

The major feature of the present invention lies in the provision of the first and second openings 15 and 16 on the outer tube 10 and the center ring 12 respectively, and the washer 17 to offer an additional fixation to the positioning of the inner tube 13, in addition to fastening member 14, so as to achieve continuously adjustable height of the tripod stand. Furthermore, due to the larger contact area between the washer 17 and the inner tube 13, tightening the bolt 18 will not scratch the surface of the inner tube 13.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A tripod stand comprising:
a tripod having a center ring;
a telescoping rod mounted on said tripod and threading through said center ring, said telescoping rod having an outer tube and an inner tube sleeved inside said outer tube;
a fastening member at the top end around said outer tube for fixing said inner tube extended for an appropriate distance from said outer tube;
wherein a first opening is provided on the circumference of said outer tube; a second opening is provided on the circumference of said center ring and aligned with said first opening; a washer is positioned between said first and second openings; and a bolt is screwed from outside, through said second opening, to squeeze on said inner tube by pressing said washer via said first opening.

2. The tripod stand according to claim 1, wherein said washer has one of the following shapes: an inversed-U shape and an L shape.

3. The tripod stand according to claim 1, wherein, when said washer has said inversed-U shape, the outer leg of said washer has a through hole aligned with and corresponding to said first and second openings.
